(19) United States
(12) Patent Application Publication
(10) Pub. No.: US 2025/0060715 A1
(43) Pub. Date: Feb. 20, 2025

(54) MODELING METHOD, GENERATION METHOD, DEVICE AND MEDIUM OF A LINK UNIT

(71) Applicants: China ENFI Engineering Corporation, Beijing (CN); China Nonferrous Engineering Co., Ltd., Beijing (CN)

(72) Inventors: CHU Jinwang, Beijing (CN); LIU Cheng, Beijing (CN); LI Bing, Beijing (CN)

(73) Assignees: China ENFI Engineering Corporation, Beijing (CN); China Nonferrous Engineering Co., Ltd., Beijing (CN)

(21) Appl. No.: 18/652,739

(22) Filed: May 1, 2024

(30) Foreign Application Priority Data
Aug. 14, 2023 (CN) 2023110148305

(51) Int. Cl. G05B 17/02; G06F 30/18; G06F 113/14

(52) U.S. Cl. CPC G05B 17/02; G06F 30/18; G06F 2113/14

(57) ABSTRACT

The invention relates to the technical field of process industry, and discloses a modeling method, a generating method, a device and a medium of a link unit. The modeling method comprises the following steps: build an inlet pipeline model; build an outlet pipeline model; build a functional equipment group model to obtain a digital model of a link unit, wherein the functional equipment group model comprises at least one functional equipment, and the types of functional equipment include at least one of the following: a buffer, a stirrer and a pressurizer, and whether each functional equipment is connected to a communication pipeline is controlled by a equipment regulator. The present disclosure can be used to integrate pipelines, buffers, stirrers, pressurizers, regulators, etc. between processes. The structured link unit greatly simplifies the building process of complex production system models.

### CROSS-REFERENCE TO RELATED APPLICATIONS

The application claims priority to Chinese patent application No. 2023110148305, filed on Aug. 14, 2023, the entire contents of which are incorporated herein by reference.

### TECHNICAL FIELD

The invention relates to the technical field of process industry, in particular to a modeling method, a generation method, a device and a medium of a link unit.

### BACKGROUND

According to the different production methods and product characteristics, manufacturing industry can be divided into two parts: discrete industry and process industry. Process industry mainly involves chemical industry, metallurgy, petrochemical industry, paper making, electric power and other industries. The production process of process industry is characterized by the flow and transformation of material and energy within the time-space boundary of manufacturing process, including physical changes, chemical changes, and changes in state, composition and properties.

In the digital modeling of the production system in the process industry, for example, in the technical field of non-ferrous metallurgy, two or more processes are usually connected through pipes or launders, and functional equipment, such as buffers, stirrers, pressurizers, regulators, etc., are arranged between processes as needed. In the related technology, the “pipeline” in logistics simulation software and system simulation software can be used to realize the transmission of fluid, and the “conveyor belt” can be used to realize the transmission of discrete objects. Buffer, agitator and pressurizer need to be designed separately and dispersed, while the production system in process industry is generally complex. Therefore, the modeling method in the prior art is not convenient for the modeling of complex production systems in process industry. It is urgent to solve this technical problem.

### SUMMARY

In view of the above situation, the embodiment of the present disclosure provides a modeling method, a generation method, a device and a medium of a link unit, aiming at solving the above problems or at least partially solving the above problems.

In a first aspect, an embodiment of the present disclosure provides a modeling method of a link unit, which includes:
Build an inlet pipeline model, wherein the inlet pipeline model comprises at least one inlet pipeline, the opening and closing of each inlet pipeline is controlled by an inlet regulator, and the connection mode between each inlet pipeline is parallel;
Build an outlet pipeline model, wherein the outlet pipeline model comprises at least one outlet pipeline, the opening and closing of each outlet pipeline is controlled by an outlet regulator, and the connection mode of each outlet pipeline is parallel;
Build a functional equipment group model, wherein the functional equipment group model comprises at least one functional equipment, and the functional equipment group model is respectively connected with the inlet pipeline model and the outlet pipeline model through pipelines, and the types of the functional equipment include at least one of the following: a buffer, a stirrer and a pressurizer, and the connection mode among the functional equipment is series or parallel, and whether each functional equipment is connected to a communication pipeline is controlled by an equipment regulator, so that complete the modeling of the link unit, and obtain the digital model of the link unit.

In one possible embodiment, the equipment regulator can control whether the functional equipment is connected to the communication pipeline according to the following methods:
Adjust the first type equipment regulator in the closed state and the second type equipment regulator in the open state, so that the functional equipment is connected to the communication pipeline, the pipeline where the first type equipment regulator is located is connected in parallel with the pipeline where the functional equipment is located, and the second type equipment regulator is adjacent to the functional equipment;
Adjust the first type equipment regulator in the open state, and adjust the second type equipment regulator in the closed state, so that the functional equipment is not connected to the communication pipeline.

In a possible embodiment, before the step of completing the modeling of the link unit and obtaining the digital model of the link unit, the modeling method further comprises:

Build a flow data configuration model, wherein the flow data configuration model configures the acquired flow data for the link unit, and the flow data includes inlet flow data and/or outlet flow data, and the data types in the flow data include at least one of the following: material flow data, energy flow data, value flow data and information flow data.

In a possible embodiment, before the step of completing the modeling of the link unit and obtaining the digital model of the link unit, the modeling method further comprises:

Build an environmental data configuration model, wherein the environmental data configuration model configured the acquired environmental data for the link unit, and the data types of the environmental data include at least one of the following: water supply data, heat supply data, power supply data, steam supply data, material data, energy data and kinetic energy replenishment data.

In the second aspect, the embodiment of the present disclosure also provides a generation method for a link unit, which uses the digital model of the link unit built by the modeling method of the link unit according to the first aspect, and the generation method comprises:
Acquire the first quantity in the previous process, the second quantity in the later process, the third quantity of target functional equipment in the target equipment group, equipment type information and connection relationship information among the target functional equipment;
According to the first quantity, the second quantity, the third quantity, the equipment type information and the connection relationship information, adjust the inlet regulator, the outlet regulator and the equipment regulator in the digital model of the link unit to obtain a target link unit, and the communication pipeline contained in the target link unit is used for connecting each previous working procedure with each subsequent working procedure and realizing the functions corresponding to each target functional equipment.

In one possible embodiment, adjust the inlet regulator, the outlet regulator and the equipment regulator in the digital model of the link unit according to the first quantity, the second quantity, the third quantity, the equipment type information and the connection relationship information to obtain the target link unit, including:
Adjust the first quantity of inlet regulators and opening the first quantity of inlet pipelines;
Adjust a second quantity of outlet regulators and opening a second quantity of outlet pipelines;
According to the third quantity, the equipment type information and the connection relationship information, adjust the equipment regulator, and connecting each target functional equipment into the communication pipeline to obtain the target link unit.

In one possible embodiment, the target equipment group includes a plurality of target functional equipment, and adjusting the equipment regulator according to the third quantity, the equipment type information and the connection relationship information to connect each target functional equipment into the communication pipeline to obtain the target link unit, including:
Adjust each equipment regulator in that digital model of the link unit to be in a closed state;
Adjust the first type equipment regulator corresponding to each functional equipment in the digital model of the link unit to be in an open state;
According to the third quantity, the equipment type information and the connection relation information, select the functional equipment in the digital model of the link unit to obtain a target functional equipment group, wherein the quantity, the equipment type information and the connection relation between the first functional equipment in the target functional equipment group are consistent with the target equipment group;
Aim at any first target functional equipment in that target functional equipment group, adjusting the second type equipment regulator correspond to the first target functional equipment to be in an open state, adjusting the first type equipment regulator corresponding to the first target functional equipment to be in a closed state, and connecting each first target functional equipment into the communication pipeline to obtain a target link unit.

In a possible embodiment, before the step of obtaining the target link unit, the generation method further comprises:
Acquire at least one flow data, wherein the flow data comprises at least one of material flow data, energy flow data, value flow data and information flow data;
Configure that at least one flow data for the digital model of the link unit.

In a possible embodiment, before the step of obtaining the target link unit, the generation method further comprises:
Acquire at least one environmental data, wherein the environmental data comprises at least one of water supply data, heat supply data, power supply data, steam supply data, material data, energy data and kinetic energy replenishment data;
Configure that at least one environmental data for the digital model of the link unit.

In a third aspect, an embodiment of the present disclosure also provides a generation device for a link unit, which is used to realize the generation method for a link unit according to any one of the second aspects, and the device comprises:
A unit information acquisition module, configured to acquire the first quantity of previous processes, the second quantity of subsequent processes, the third quantity of target functional equipment in the target equipment group, equipment type information and connection relationship information among the target functional equipment;
A unit building module, configured to adjust an inlet regulator, an outlet regulator and an equipment regulator in the digital model of the link unit according to the first quantity, the second quantity, the third quantity, the equipment type information and the connection relationship information, so as to obtain a target link unit, wherein the communication pipeline contained in the target link unit is used for connecting each preceding process with each succeeding process and realizing the functions corresponding to each target functional equipment.

In the fourth aspect, the embodiment of the present disclosure also provides a computer-readable storage medium that stores one or more programs, when one or more programs are executed by an electronic device including a plurality of application programs, cause the electronic device to execute the steps of the modeling method of the link unit or the generation method of the link unit.

At least one technical scheme adopted by the embodiment of the present disclosure can achieve the following beneficial effects:
The modeling method of the link unit provided by the embodiment of the disclosure creatively proposes and constructs a digital model of the link unit, specifically, an inlet pipeline model can be constructed, and the inlet pipeline model comprises at least one inlet pipeline controlled by an inlet regulator; Constructing an outlet pipeline model, wherein the outlet pipeline model comprises at least one outlet pipeline controlled by an outlet regulator, and the connection mode between the inlet pipelines and the outlet pipelines is parallel; Constructing a functional equipment group model, wherein the functional equipment group model comprises at least one functional equipment, and the types of the functional equipment include at least one of the following: a buffer, a stirrer and a pressurizer, and the connection mode between the functional equipment is series or parallel, and whether the functional equipment is connected into a communication pipe is controlled by an equipment regulator, so that complete the modeling of the link unit, and obtain the digital model of the link unit. It can be seen that the digital model of link unit can integrate pipelines, functional equipment (such as buffers, stirrers, pressurizers) and regulators between processes. Compared with the prior art, the structured link unit greatly simplifies the construction process of complex production system model, and realizes the production collaboration and functional coupling between processes.

### BRIEF DESCRIPTION OF DRAWINGS

The drawings illustrated here are provided to provide a further understanding of the disclosure and constitute a part of the disclosure. The illustrative embodiments of the disclosure and their descriptions are used to explain the disclosure and do not constitute undue limitations on the disclosure. In the drawings:

FIG. 1 shows a flowchart of a modeling method of a link unit provided by an embodiment of the present disclosure;

FIG. 2 shows a schematic structural diagram of a digital model of a link unit provided by an embodiment of the present disclosure;

FIG. 3 shows a schematic diagram of an equipment regulator control function equipment provided by an embodiment of the present disclosure;

FIG. 4 shows a flowchart of a modeling method of a link unit provided by another embodiment of the present disclosure;

FIG. 5 shows a flowchart of a generation method for a link unit provided by an embodiment of the present disclosure;

FIG. 6 shows a partial structural schematic diagram of a digital model of a link unit provided by an embodiment of the present disclosure;

FIG. 7 shows a partial structural schematic diagram of a digital model of a link unit provided by another embodiment of the present disclosure;

FIG. 8 shows a flowchart of a generation method for a link unit provided by another embodiment of the present disclosure;

FIG. 9 shows a schematic flowchart of the hydrometallurgical process of low-grade laterite nickel ore provided by the embodiment of the present disclosure;

FIG. 10 shows a partial flowchart of the hydrometallurgical process of low-grade laterite-nickel ore provided by the embodiment of the present disclosure;

FIG. 11 shows a structural schematic diagram of a modeling device of a link unit provided by an embodiment of the present disclosure;

FIG. 12 shows a structural schematic diagram of a generation device of a link unit provided by an embodiment of the present disclosure;

FIG. 13 shows a schematic structural diagram of an electronic device provided by an embodiment of the present disclosure.

### DETAILED DESCRIPTION OF THE EMBODIMENTS

In order to make the purpose, technical scheme and advantages of this disclosure more clear, the technical scheme of this disclosure will be described clearly and completely with specific embodiments of this disclosure and corresponding drawings. Obviously, the described embodiment is only a part of the embodiment of the present disclosure, not the whole embodiment. Based on the embodiments in this disclosure, all other embodiments obtained by ordinary technicians in this field without creative work belong to the scope of protection in this disclosure.

It should be noted that the terms “first” and “second” in the description and claims of this disclosure and the above drawings are used to distinguish similar objects, and are not necessarily used to describe a specific order or sequence. It should be understood that such use are interchangeable under appropriate circumstance, so that that embodiments of the disclosure described herein can be implemented in order other than those illustrated or described herein. Furthermore, the term “including” and its variants are to be interpreted as an open-ended term meaning “including but not limited to”.

As mentioned above, in the related technology, the “pipeline” in logistics simulation software and system simulation software is used to realize the transmission of fluid, and the “conveyor belt” is used to realize the transmission of discrete objects. Buffers, stirrers and pressurizers need to be designed separately and dispersed, while the production system in process industry is generally more complex, so the modeling method in the prior art is not convenient for the modeling of complex production systems in process industry. Based on this, the invention provides a modeling method, a generation method, an equipment and a medium of a link unit. Through the digital model of the link unit, pipelines, functional equipment (such as buffers, stirrers and pressurizers) and regulators among processes can be integrated together. Compared with the prior art, the structured link unit greatly simplifies the construction process of a complex production system model, and realizes the production collaboration and functional coupling among processes. The present disclosure will be described in detail below through specific embodiments.

For the convenience of understanding this embodiment, firstly, a modeling method of a link unit disclosed in this disclosure embodiment is introduced in detail. The execution subject of the modeling method of a link unit provided in this disclosure embodiment is generally a computer equipment with certain computing power, which includes, for example, a terminal equipment or a server or other processing equipment, and the terminal equipment can be a User Equipment (UE), a mobile equipment, a user terminal, a terminal, and a Personal Digital Assistant (PDA), etc. In some possible implementations, the modeling method of the link unit can be realized by the processor calling the computer-readable instructions stored in the memory.

The modeling method of the link unit provided by the embodiment of the present disclosure is used to create a simulation digital model of the link unit. As mentioned in the background, when constructing a digital model of a process industrial production system, two or more processes are usually connected through pipelines or launders, and functional equipment, such as buffers, stirrers, pressurizers, regulators, etc., are also arranged between processes as required. The technical scheme of the embodiment of the present disclosure integrates the pipes or launders and various functional equipment to form the aforementioned link unit.

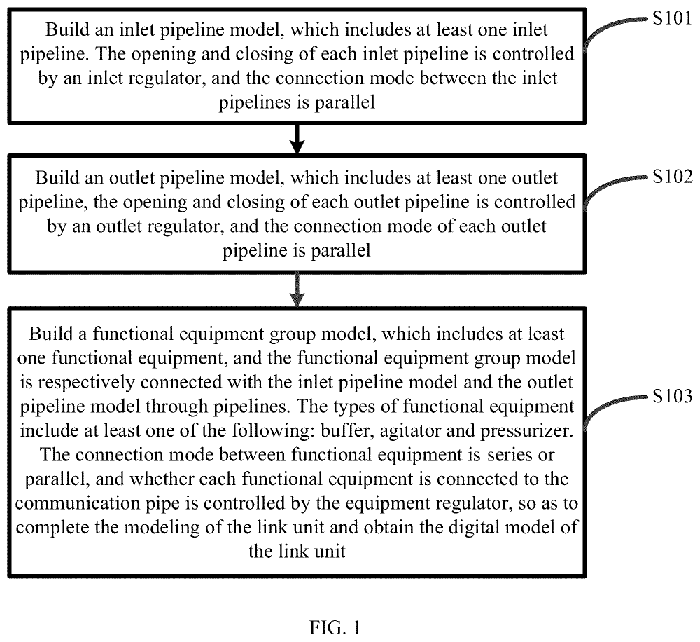

FIG. 1 shows a flowchart of a modeling method of a link unit provided by an embodiment of the present disclosure. As can be seen from FIG. 1, the embodiment of the present disclosure at least includes steps S101˜S103:

Step S101: Build an inlet pipeline model, which includes at least one inlet pipeline. The opening and closing of each inlet pipeline is controlled by an inlet regulator, and the connection mode between the inlet pipelines is parallel.

Step S102: Build an outlet pipeline model, which includes at least one outlet pipeline, the opening and closing of each outlet pipeline is controlled by an outlet regulator, and the connection mode of each outlet pipeline is parallel.

Step S103: Build a functional equipment group model, which includes at least one functional equipment, and the functional equipment group model is respectively connected with the inlet pipeline model and the outlet pipeline model through pipelines. The types of functional equipment include at least one of the following: buffer, agitator and pressurizer. The connection mode between functional equipment is series or parallel, and whether each functional equipment is connected to the communication pipe is controlled by the equipment regulator, so as to complete the modeling of the link unit and obtain the digital model of the link unit.

Whether each functional equipment is connected to the connecting pipeline is controlled by the equipment regulator. In one possible embodiment, the equipment regulator can control whether the functional equipment is connected to the communication pipeline according to the following methods:

Mode 1: Adjust the first type equipment regulator in the closed state, and adjust the second type equipment regulator in the open state, so that the functional equipment is connected to the communication pipeline. The pipeline where the first type equipment regulator is located is connected in parallel with the pipeline where the functional equipment is located, and the second type equipment regulator is adjacent to the functional equipment.

Mode 2: Adjust the first type equipment regulator in the open state, and adjust the second type equipment regulator in the closed state, so that the functional equipment is not connected to the communication pipeline.

As can be seen from the method shown in FIG. 1, the embodiment of the present disclosure creatively proposes and constructs a digital model of a link unit, specifically, an inlet pipeline model can be constructed, and the inlet pipeline model includes at least one inlet pipeline controlled by an inlet regulator; Constructing an outlet pipeline model, wherein the outlet pipeline model comprises at least one outlet pipeline controlled by an outlet regulator, and the connection mode between the inlet pipelines and the outlet pipelines is parallel; Constructing a functional equipment group model, wherein the functional equipment group model comprises at least one functional equipment, and the types of the functional equipment include at least one of the following: a buffer, a stirrer and a pressurizer, and the connection mode between the functional equipment is series or parallel, and whether the functional equipment is connected into a communication pipe is controlled by an equipment regulator, so that the modeling of the link unit is completed, and obtain the digital model of the link unit. It can be seen that the digital model of link unit can integrate pipelines, functional equipment (such as buffers, stirrers, pressurizers) and regulators between processes. Compared with the prior art, the structured link unit greatly simplifies the construction process of complex production system model, and realizes the production collaboration and functional coupling between processes.

The following is a relatively specific description of the above steps.

For step S101 and step S102:

First of all, it should be noted that the embodiment of this disclosure does not limit the execution order of steps S101˜S103.

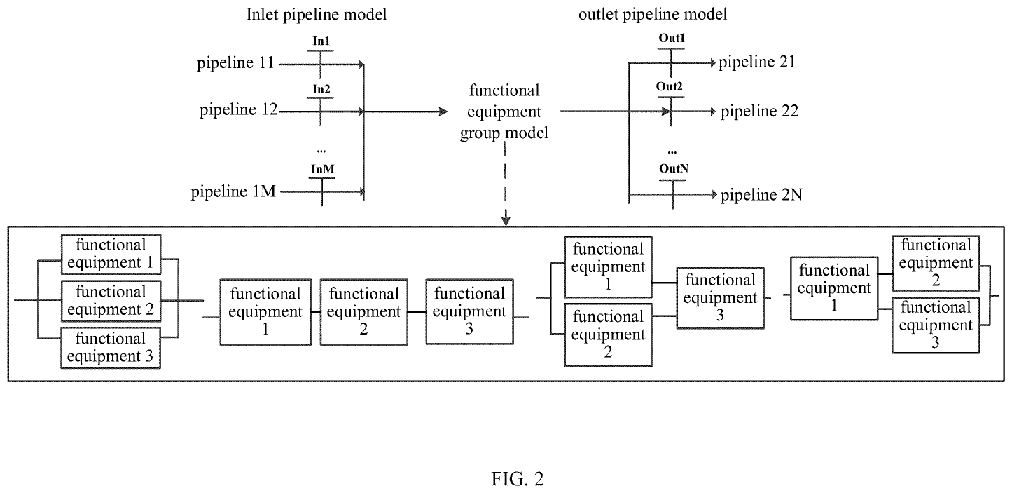

FIG. 2 shows a schematic structural diagram of a digital model of a link unit provided by an embodiment of the present disclosure, and steps S101 and S102 will be exemplified with reference to FIG. 2.

Referring to FIG. 2, an inlet pipeline model including at least one inlet pipeline can be constructed, including pipeline 11, pipeline 12, . . . and pipeline 1M, all of which are connected in parallel, and the opening and closing of pipeline 11 is controlled by inlet regulator In1; The opening and closing of the pipeline 12 is controlled by the inlet regulator In2; The opening and closing of the pipeline 1M is controlled by the inlet regulator InM. An outlet pipeline model including at least one outlet pipeline, pipeline 21, pipeline 22, . . . , and pipeline 2N, can be constructed, and the outlet pipelines are connected in parallel, and the opening and closing of pipeline 21 is controlled by outlet regulator Out1; The opening and closing of the pipeline 22 is controlled by the outlet regulator Out2; The opening and closing of the pipeline 2N is controlled by the outlet regulator OutN. When it is implemented, the inlet pipeline model can also configure the diameter of each inlet pipeline, and the outlet pipeline model can also configure the diameter of each outlet pipeline.

For step S103:

The types of functional equipment include, but are not limited to, buffers, stirrers and pressurizers, wherein the buffers can be composed of multiple buffer tanks. During implementation, the types of functional equipment can be set according to process requirements, for example, the types of functional equipment can also be centrifugal pumps, crushers, filters, etc., which is not limited by this disclosure.

Referring to FIG. 2, a functional equipment group model including functional equipment 1, functional equipment 2 and functional equipment 3 can be constructed, and the functional equipment group model is respectively connected with the inlet pipeline model and the outlet pipeline model through pipelines, and the connection modes among the functional equipment can be as follows: functional equipment 1, functional equipment 2 and functional equipment 3 are connected in parallel; Functional equipment 1, functional equipment 2 and functional equipment 3 are connected in series; Functional equipment 1 and functional equipment 2 are connected in parallel and connected in series with functional equipment 3; functional equipment 2 and functional equipment 3 are connected in parallel and connected in series with functional equipment 1.

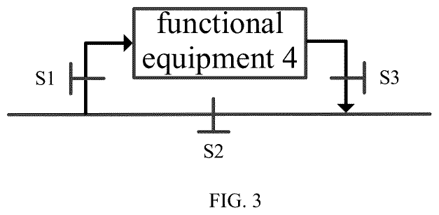

FIG. 3 shows the schematic diagram of the equipment regulator controlling the functional equipment provided by the embodiment of the present disclosure, and the principle of the equipment regulator controlling the functional equipment will be exemplified with reference to FIG. 3. As shown in FIG. 3, in this embodiment, the pipeline where S2 is located is connected in parallel with the pipeline where functional equipment 4 is located, which is the first type equipment regulator, and S1 and S3 are adjacent to functional equipment 4, which are the second type equipment regulators. Turn off S2, turn on S1 and S3, so that substances pass through the functional equipment, that is, the functional equipment 4 is connected into the communication pipeline; turn on S2, and turn off S1 and S3, so that the substance passes through the pipeline where S2 is located, that is, the functional equipment 4 is not connected to the communication pipeline. When implemented, the functional equipment group model can also configure equipment attribute information for functional equipment, for example, buffer capacity information can be configured for buffers, information such as volume, stirring speed and power can be configured for mixers, and information such as flow rate and head can be configured for pressurizers.

In specific application scenarios, the existing logistics simulation and system simulation software can simulate the flow of material flow and limited information flow, but can not meet the needs of reality for simulating information flow, energy flow and value flow. Based on this, in one possible embodiment, before completing the step of modeling the link unit and obtaining the digital model of the link unit, the modeling method further includes:

Step A, Build a flow data configuration model, wherein the flow data configuration model is the flow data acquired by link unit configuration, and the flow data includes inlet flow data and/or outlet flow data, and the data types in the flow data include at least one of the following: material flow data, energy flow data, value flow data and information flow data.

In this embodiment, the material flow data includes the material objects processed or acquired in each process. For example, taking the hydrometallurgy of low-grade laterite nickel ore as an example, the material flow includes laterite nickel ore slurry and product slurry. Energy flow data includes internal energy, mechanical energy and chemical energy in each process. Value stream data includes cost and the value of each substance. Information flow data includes information of production process, production control information (for example, temperature and pressure), material flow information (for example, laterite nickel ore slurry includes laterite nickel ore and water, laterite nickel ore and mineral components, water flow, etc.), monitoring information, etc. The present disclosure does not limit the data types in the flow data. When implemented, the flow data can be inlet material flow data, outlet material flow data, inlet value flow data and export value flow data.

In this embodiment, by adding a flow data configuration model to the link unit digital model, the link unit digital model can not only realize the transfer and transfer of material flow between processes, but also realize the transmission and transfer of energy flow, value flow, information flow and other flows, thus meeting the actual needs for energy data, value data and information data in each process.

In specific application scenarios, the functional equipment integrated in the link unit model needs external resources, such as power supply to the electric regulator, water supply and power supply to the pressurizer. Based on this, in one possible embodiment, before the step of modeling the link unit and obtaining the digital model of the link unit is completed, the modeling method further includes:

Step B, Build an environmental data configuration model, wherein the environmental data configuration model is the environmental data acquired by link unit configuration, and the data types of the environmental data include at least one of the following: water supply data, heat supply data, power supply data, steam supply data, material data, energy data and kinetic energy replenishment data. For example, the environmental data configuration model can configure water supply data; can also configure heat supply data and power supply data; can also configure water supply data, heat supply data, power supply data, steam supply data and material data.

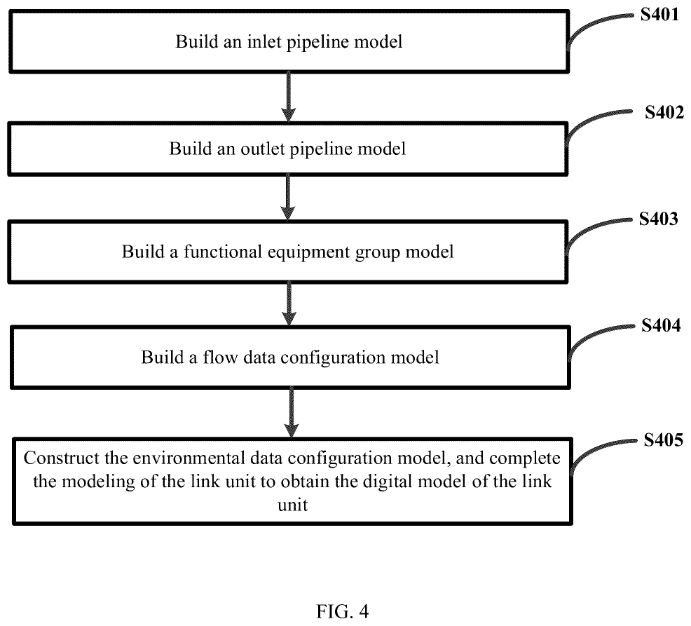

FIG. 4 shows a flowchart of a modeling method of a link unit provided by another embodiment of the present disclosure. As can be seen from FIG. 4, this embodiment includes the following steps S401˜ to S405:

Step S401: Build an inlet pipeline model. The inlet pipeline model includes at least one inlet pipeline, the opening and closing of each inlet pipeline is controlled by an inlet regulator, and the connection mode of each inlet pipeline is parallel.

Step S402: Build an outlet pipeline model. The outlet pipeline model includes at least one outlet pipeline, and the opening and closing of each outlet pipeline is controlled by an outlet regulator, and the connection mode of each outlet pipeline is parallel.

Step S403: Build a functional equipment group model. The functional equipment group model includes at least one functional equipment, which is respectively connected with the inlet pipeline model and the outlet pipeline model through pipelines. The types of functional equipment include at least one of the following: buffer, agitator and pressurizer. The connection mode between functional equipment is series or parallel, and whether each functional equipment is connected to the communication pipe is controlled by the equipment regulator. Specifically, the equipment regulator can control whether the functional equipment is connected to the communication pipeline according to the following methods: adjusting the first type equipment regulator in the closed state, adjusting the second type equipment regulator in the open state, so that the functional equipment is connected to the communication pipeline, the pipeline where the first type equipment regulator is located is connected in parallel with the pipeline where the functional equipment is located, and the second type equipment regulator is adjacent to the functional equipment; Adjust the first type equipment regulator in the open state, and adjust the second type equipment regulator in the closed state, so that the functional equipment is not connected to the communication pipeline.

Step S404: Build a flow data configuration model. The flow data configuration model configures the acquired flow data for the link unit, which includes inlet flow data and/or outlet flow data, and the data types in the flow data include at least one of the following: material flow data, energy flow data, value flow data and information flow data.

Step S405: Build the environmental data configuration model, and complete the modeling of the link unit to obtain the digital model of the link unit. The environmental data configuration model configured the acquired environmental data for the link unit, and the data types of environmental data include at least one of the following: water supply data, heat supply data, power supply data, steam supply data, material data, energy data and kinetic energy replenishment data.

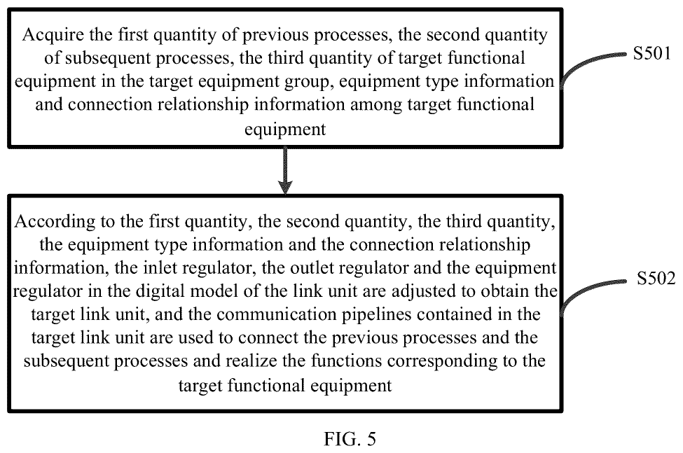

Based on the same idea, the embodiment of the present disclosure also provides a generation method of the link unit, using the digital model of the link unit constructed according to the modeling method of the link unit. FIG. 5 shows a flowchart of a generation method for a link unit provided by an embodiment of the present disclosure. As can be seen from FIG. 5, the embodiment of the present disclosure at least includes steps S501˜S502:

Step S501: Acquire the first quantity of previous processes, the second quantity of subsequent processes, the third quantity of target functional equipment in the target equipment group, equipment type information and connection relationship information among target functional equipment.

Step S502: According to the first quantity, the second quantity, the third quantity, the equipment type information and the connection relationship information, the inlet regulator, the outlet regulator and the equipment regulator in the digital model of the link unit are adjusted to obtain the target link unit, and the communication pipelines contained in the target link unit are used to connect the previous processes and the subsequent processes and realize the functions corresponding to the target functional equipment.

In this embodiment, obtain the first quantity in the previous process, the second quantity in the later process, the third quantity of target functional equipment in the target equipment group, equipment type information and connection relationship information among target functional equipment. Wherein, the connection relationship information includes parallel connection and series connection, and when the third quantity is 1, the connection relationship information between the target functional equipment is empty. For example, the acquired data are: the first quantity in the previous process is 2, and the first quantity in the later process is 3. The target equipment group includes target functional equipment 1, and the equipment type of target functional equipment 1 is buffer. For another example, the acquired data are: the first quantity in the previous process is 1, and the first quantity in the later process is 1. The target equipment group includes target functional equipment 2 and target functional equipment 3. The equipment type of target functional equipment 2 is a buffer, the equipment type of target functional equipment 3 is a blender, and the connection relationship information between target functional equipment 2 and target functional equipment 3 is a series connection.

Then, according to the first quantity, the second quantity, the third quantity, the equipment type information and the connection relationship information, the inlet regulator, the outlet regulator and the equipment regulator in the digital model of the link unit are adjusted to obtain the target link unit. Specifically, in one possible embodiment, step S502, that is, according to the first quantity, the second quantity, the third quantity, the equipment type information and the connection relationship information, adjusts the inlet regulator, the outlet regulator and the equipment regulator in the digital model of the link unit to obtain the target link unit, which specifically includes:

Step S5021: adjust the first quantity of inlet regulators and open the first quantity of inlet pipes.

Step S5022: adjust the second quantity of outlet regulators and open the second quantity of outlet pipelines.

Step S5023: according to the third quantity, the equipment type information and the connection relationship information, adjust the equipment regulator, and connect the target functional equipment into the communication pipeline to obtain the target link unit.

It should be noted that before obtain the target link unit, the execution order of steps S5021˜ to S5023 is not limited in this embodiment of the disclosure.

Referring to FIG. 2, if the first quantity is 2, the inlet regulators In1 and In2 can be adjusted to be in the open state, and other inlet regulators can be adjusted to be in the closed state, so as to open the pipelines 11 and 12; If the second quantity is 3, the outlet regulators Out1, Out2 and Out3 can be adjusted to be in the open state, and other outlet regulators can be adjusted to be in the closed state, and open the pipelines 21, 22 and 23 can.

Then, according to the third quantity, the equipment type information and the connection relationship information, the equipment regulator can be adjusted to connect the target functional equipment into the communication pipeline.

Specifically, if the target equipment group includes a plurality of target functional equipment, in one possible embodiment, step S5023, that is, according to the third quantity, the equipment type information and the connection relationship information, adjusts the equipment regulator, and connects each target functional equipment into the communication pipeline to obtain the target link unit, which specifically includes:

Step S5023-1-1: Adjust each equipment regulator in the digital model of the link unit to be in the closed state.

Step S5023-1-2: Adjust the first type equipment regulator corresponding to each functional equipment in the digital model of the link unit to be in the open state.

Step S5023-1-3: Select the functional equipment in the digital model of the link unit according to the third quantity, equipment type information and connection relationship information to obtain the target functional equipment group, and the quantity, equipment type information and connection relationship between the first functional equipment in the target functional equipment group are consistent with the target equipment group.

Step S5023-1-4: For any first target functional equipment in the target functional equipment group, adjust the second type equipment regulator corresponding to the first target functional equipment to be in the open state, adjust the first type equipment regulator corresponding to the first target functional equipment to be in the closed state, and connect each first target functional equipment into the communication pipeline to obtain the target link unit.

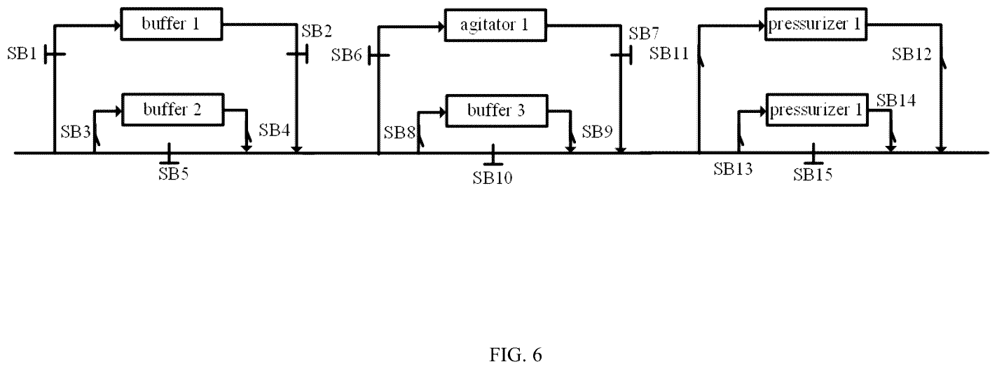

FIG. 6 shows a partial structural schematic diagram of the digital model of the link unit provided by the embodiment of the present disclosure. Next, this embodiment will be exemplified with reference to FIG. 6.

Referring to FIG. 6, the digital model of the link unit includes the following functional equipment: buffer 1, buffer 2, agitator 1, buffer 3, pressurizer 1 and pressurizer 2, and the following equipment regulators: SB1, SB2, SB3, SB4, SB5, SB6, SB7, SB8, SB9, SB10, SB11, SB12, SB13, SB14, SB15. Suppose that the target functional equipment group includes target functional equipment B1, target functional equipment B2, target functional equipment B3 and target functional equipment B4, the equipment type information of the target functional equipment B1 and target functional equipment B2 is a buffer, the equipment type information pressurizer of the target functional equipment B3 and target functional equipment B4 is connected in series, the target functional equipment B3 is connected in parallel, and the target functional equipment B3/target functional equipment B4 is connected in series respectively.

First, adjust each equipment regulator SB1, SB2, SB3, SB4, SB5, SB6, SB7, SB8, SB9, SB10, SB11, SB12, SB13, SB14 and SB15 in the digital model of the link unit in FIG. 6 to be in the off state; Adjust the first type equipment regulators SB5, SB10 and SB15 corresponding to each functional equipment in the digital model of the link unit to be in the open state.

Then, according to the third quantity, the equipment type information and the connection relationship information, the functional equipment in the digital model of the link unit are selected to obtain the target functional equipment group. For example, a target functional equipment group can be obtained, including the following first functional equipment: buffer 2, buffer 3, pressurizer 1 and pressurizer 2, wherein buffer 2 is connected in series with buffer 3, pressurizer 1 is connected in parallel with pressurizer 2, and pressurizer 1/pressurizer 2 is connected in series with buffer 2/buffer 3.

Then, aiming at any first target functional equipment in the target functional equipment group, the second type equipment regulator corresponding to the first target functional equipment is adjusted to be in an open state, and the first type equipment regulator corresponding to the first target functional equipment is adjusted to be in a closed state, and each first target functional equipment is connected into a communication pipeline to obtain a target link unit. For example, the second type equipment regulators SB3 and SB4 of the buffer 2 can be adjusted in the open state, and the first type equipment regulator SB5 of the buffer 2 can be adjusted in the closed state. The second type equipment regulators SB8 and SB9 of the buffer 3 are adjusted in the open state, and the first type equipment regulator SB10 of the buffer 3 is in the closed state. The second type equipment regulators SB11 and SB 12 of the pressurizer 1 are adjusted in the open state, and the first type equipment regulators SB15 of the pressurizer 1 are adjusted in the closed state; The second type equipment regulators SB13 and SB14 of the pressurizer 2 are adjusted in the open state (the first type equipment regulator SB15 of the pressurizer 2 is already in the closed state, and no adjustment is needed). At this point, each first target functional equipment can be connected to the communication pipeline to obtain the target link unit. During implementation, the buffer capacities of the buffers 2 and 3 can also be obtained, and the aforementioned equipment attribute information can be configured for the buffers 2 and 3 in the digital model of the link unit. It is also possible to obtain the flow and lift of the pressurizer 1 and the pressurizer 2, and configure the aforementioned equipment attribute information for the pressurizer 1 and the pressurizer 2 in the digital model of the link unit.

In a specific application scenario, if the target equipment group includes a target functional equipment, in one possible embodiment, step S5023, that is, according to the third quantity, the equipment type information and the connection relationship information, adjusts the equipment regulator, and connects each target functional equipment into the communication pipeline to obtain the target link unit, which specifically includes:

Step S5023-2-1: Adjust each equipment regulator in the digital model of the link unit to be in the closed state.

Step S5023-2-2: Adjust the first type equipment regulator corresponding to each functional equipment in the digital model of the link unit to be in the open state.

Step S5023-2-3: Adjust the second type of equipment regulator corresponding to the second functional equipment in the digital model of the link unit to be in the open state, adjust the first type of equipment regulator corresponding to the second functional equipment to be in the closed state, and connect the second functional equipment into the communication pipeline to obtain the target link unit, wherein the equipment type information of the second functional equipment is the same as that of the target functional equipment.

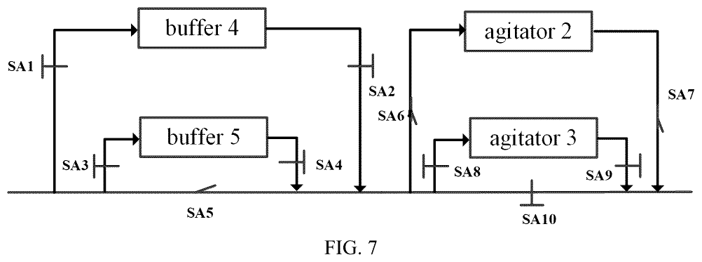

FIG. 7 shows a partial structural schematic diagram of a digital model of a link unit provided by another embodiment of the present disclosure. Next, this embodiment will be exemplified with reference to FIG. 7.

Referring to FIG. 7, the digital model of the link unit includes the following functional equipment: buffer 4, buffer 5, agitator 2 and agitator 3, and the following equipment regulators: SA1, SA2, SA3, SA4, SA5, SA6, SA7, SA8, SA9 and SA10. First, all the equipment regulators SA1, SA2, SA3, SA4, SA5, SA6, SA7, SA8, SA9 and SA10 in the digital model of the link unit can be adjusted to be in the closed state; Then, adjust all the first type equipment regulators SA5 and SA10 in the digital model of the link unit to be in the on state.

If the target equipment group includes the target functional equipment A, and the equipment type information of the target functional equipment A is an agitator, select the functional equipment in the digital model in FIG. 7 to obtain the agitator 2 with the equipment type information as an agitator, then can adjust the second type equipment adjusters SA6 and SA7 corresponding to the stirrer 2 in FIG. 7 to be in the open state, and adjust the first type equipment adjusters SA10 corresponding to the agitator 2 can to be in the closed state. So far, the agitator 2 can be connected to the communication pipeline to obtain the target link unit. During implementation, acquire the volume, stirring speed, power, etc. of the agitator 2 and the aforementioned equipment attribute data can be configured for the agitator 2 in the digital model of the link unit.

In a specific application scenario, in one possible embodiment, before the step of obtaining the target link unit, the generation method further comprises:

Step B1: acquiring at least one flow data, wherein the flow data comprises at least one of the following: material flow data, energy flow data, value flow data and information flow data.

Step B2: configure at least one flow data for that digital model of the link unit. For example, one material flow data, a ton of material A, can be obtained, and a ton of material A can be used as inlet flow data or outlet flow data, and the flow data can be configured for the digital model of the link unit. For another example, you can obtain two value stream data, namely, b ten thousand yuan and (b+c) ten thousand yuan, and use B ten thousand yuan as the inlet flow data and (b+c) ten thousand yuan as the outlet flow data, and configure the flow data for the digital model of the link unit.

In a specific application scenario, in one possible embodiment, before the step of obtaining the target link unit, the generation method further comprises:

Step C1, obtain at least one environmental data, wherein the environmental data comprises at least one of water supply data, heat supply data, power supply data, steam supply data, material data, energy data and kinetic energy replenishment data;

Step C2, configure at least one environmental data for that digital model of the link unit.

During implementation, the functional equipment configured by the digital model of the link unit needs external resources. For example, if a pressurizer is configured by the digital model of the link unit, the normal operation of the pressurizer needs water supply and power supply, then the water supply data and power supply data can be obtained by using the environmental data configuration model in the digital model of the link unit, for example, the water supply data is B ten thousand cubic meters/day and the power supply data is C kWh/day, and the aforementioned environmental data can be configured for the digital model of the link unit. The type of environmental data is not limited in this disclosure, and can be set according to actual needs.

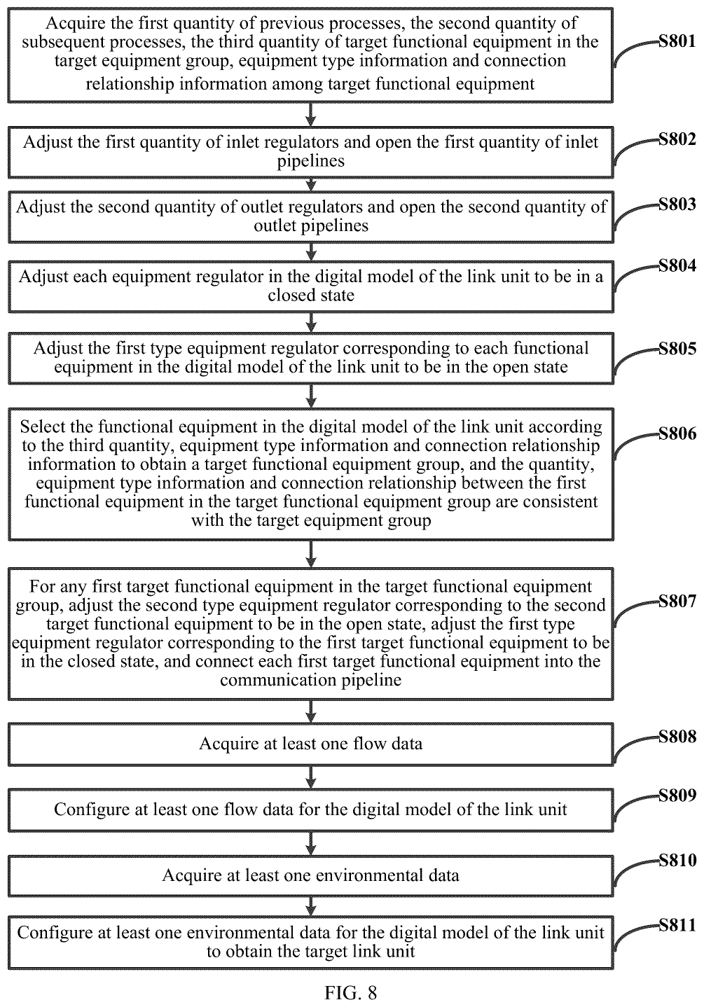

FIG. 8 shows a flowchart of a generation method for a link unit provided by another embodiment of the present disclosure. As can be seen from FIG. 8, this embodiment includes the following steps S801˜ to S811:

Step S801: Obtain the first quantity of previous processes, the second quantity of subsequent processes, the third quantity of target functional equipment in the target equipment group, equipment type information and connection relationship information among target functional equipment.

Step S802: Adjust the first quantity of inlet regulators and open the first quantity of inlet pipelines.

Step S803: Adjust the second quantity of outlet regulators and open the second quantity of outlet pipelines.

Step S804: Adjust each equipment regulator in the digital model of the link unit to be in a closed state.

Step S805: Adjust the first type equipment regulator corresponding to each functional equipment in the digital model of the link unit to be in the open state.

Step S806: Select the functional equipment in the digital model of the link unit according to the third quantity, equipment type information and connection relationship information to obtain a target functional equipment group, and the quantity, equipment type information and connection relationship between the first functional equipment in the target functional equipment group are consistent with the target equipment group.

Step S807: For any first target functional equipment in the target functional equipment group, adjust the second type equipment regulator corresponding to the second target functional equipment to be in the open state, adjust the first type equipment regulator corresponding to the first target functional equipment to be in the closed state, and connect each first target functional equipment into the communication pipeline.

Step S808: Acquire at least one flow data. The flow data includes at least one of the following: material flow data, energy flow data, value flow data and information flow data.

Step S809: Configure at least one flow data for the digital model of the link unit.

Step S810: Acquire at least one environmental data. Environmental data includes at least one of the following: water supply data, heat supply data, power supply data, steam supply data, material data, energy data and kinetic energy replenishment data.

Step S811: Configure at least one environmental data for the digital model of the link unit to obtain the target link unit. The communication pipeline contained in the target link unit is used to connect each previous process with each subsequent process, and realize the corresponding functions of each target functional equipment.

Taking the hydrometallurgy of low-grade laterite nickel ore as an example, combining with the digital model of link unit shown in FIG. 1 and FIG. 6, the generation method of the aforementioned link unit will be exemplified.

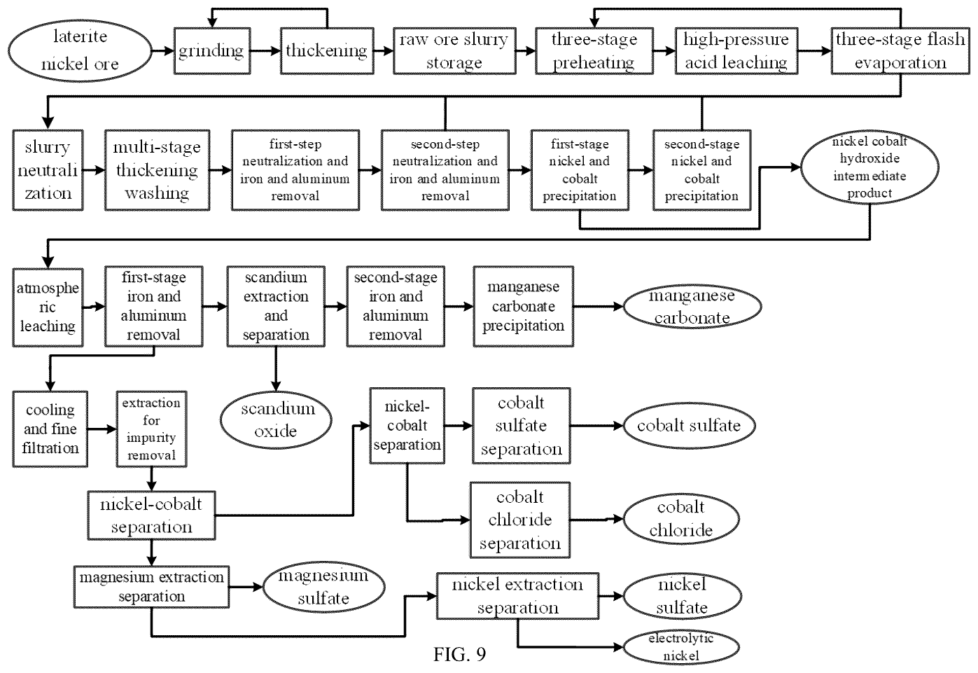

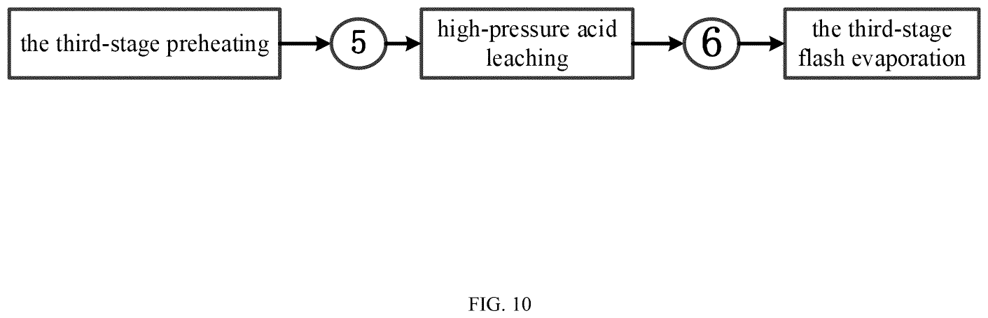

FIG. 9 shows the process flow diagram of hydrometallurgy of low-grade laterite nickel ore provided by the embodiment of the present disclosure, in which the box represents the processing process and the oval box represents the blanking process or the output process. Referring to FIG. 9, the hydrometallurgy of low-grade laterite nickel ore includes the following procedures: laterite nickel ore, grinding, thickening, raw ore slurry storage, three-stage preheating, high-pressure acid leaching, three-stage flash evaporation, slurry neutralization, multi-stage thickening washing, first-step neutralization and iron and aluminum removal, second-step neutralization and iron and aluminum removal, first-stage nickel and cobalt precipitation, second-stage nickel and cobalt precipitation, nickel cobalt hydroxide intermediate product, atmospheric leaching, first-stage iron and aluminum removal, scandium extraction and separation, scandium oxide, second-stage iron and aluminum removal, manganese carbonate precipitation, manganese carbonate, cooling and fine filtration, extraction for impurity removal, nickel-cobalt separation, nickel-cobalt separation, cobalt sulfate separation, cobalt sulfate, cobalt chloride separation, cobalt chloride and magnesium extraction separation, magnesium sulfate, nickel extraction separation, nickel sulfate and electrolytic nickel. FIG. 10 shows a partial flow diagram of the hydrometallurgical process of low-grade laterite nickel ore provided by the embodiment of the present disclosure. As shown in FIG. 10, circles with numbers indicate link units. In the complex production system of laterite nickel hydrometallurgy, the third-stage preheating process and high-pressure acid leaching process are connected by No.5 link unit, and the high-pressure acid leaching process and the third-stage flash evaporation process are connected by No.6 link unit. Here, take No.5 link unit as an example.

The prior process of No.5 link unit is a three-stage preheating process, and the subsequent process is a high-pressure acid leaching process, that is, both the first quantity and the second quantity are 1. No.5 link unit needs a pressurizer, that is, the third quantity is 1, and the equipment type information is pressurizer. Then the inlet regulator In1 can be adjusted to open an inlet pipeline for connecting the three-stage preheating process; Adjust the outlet regulator Out1, and open an outlet pipeline for linking the high-pressure acid leaching process, wherein the inner diameter of the pipeline can be configured to be 320 mm; Adjust each equipment regulator in FIG. 6 to be in the closed state; Adjust the first type equipment regulators SB5, SB10 and SB15 corresponding to each functional equipment to be in the open state; Select the functional equipment in the digital model of the link unit in FIG. 6 to obtain the target functional equipment group including the pressurizer 1; Adjust the second type equipment regulators SB11 and SB12 corresponding to the pressurizer 1 in the open state, and adjust the first type equipment regulator SB15 corresponding to the pressurizer 1 in the closed state, so as to connect the pressurizer 1 into the communication pipeline, and the pressurizer can be configured with a flow rate of 528 m3/h and a lift of 5.2 MPa.

In this example, the material flow data include: raw laterite nickel ore 200 t/h; The information flow data include: the specific gravity of laterite nickel ore is 2.7, the slurry liquid-solid ratio is 2:1, and the fluctuation coefficient is 1.1; The specific gravity of the slurry is 1.26, the normal flow rate is 480 m3/h, the maximum flow rate is 528 m3/h, the minimum flow rate is 432 m3/h, and the resistance loss along the way is 0.015; The production pressure of high pressure acid leaching is 5.0 MPa. The aforementioned flow data can be configure for that digital model of the link unit.

In this embodiment, if it is necessary to supply power to the electric regulator and supply water and power to the pressurizer, the environmental data can be configured for the digital model of the link unit as follows: power supply data: M kWh/day, water supply data: N million cubic meters/day.

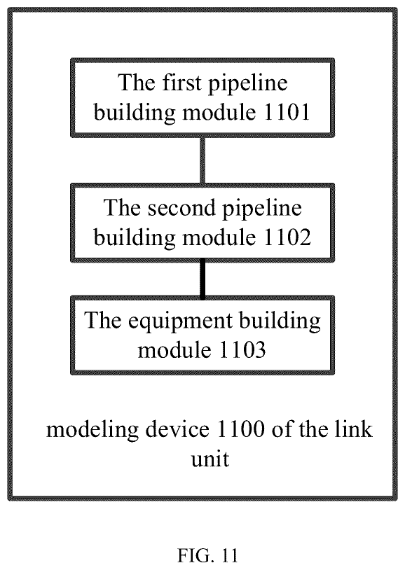

Based on the same concept, the embodiment of the present disclosure also provides a modeling device of a link unit, and FIG. 11 shows a structural schematic diagram of the modeling device of the link unit provided by the embodiment of the present disclosure. Referring to FIG. 11, the modeling device 1100 of the link unit provided by the embodiment of the present disclosure includes:

The first pipeline building module 1101 is used to build an inlet pipeline model, which includes at least one inlet pipeline, the opening and closing of each inlet pipeline is controlled by an inlet regulator, and the connection mode between each inlet pipeline is parallel.

The second pipeline building module 1102 is used to build an outlet pipeline model, which includes at least one outlet pipeline, the opening and closing of each inlet pipeline is controlled by an outlet regulator, and the connection mode between each outlet pipeline is parallel.

The equipment building module 1103 is used for building a functional equipment group model, which includes at least one functional equipment, and the functional equipment group model is connected with the inlet pipeline model and the outlet pipeline model respectively through pipelines, and the types of the functional equipment include at least one of the following: a buffer, a stirrer and a pressurizer, and the connection mode between the functional equipment is series or parallel, and whether each functional equipment is connected to a communication pipe is controlled by an equipment regulator to complete the modeling of the link unit. The equipment regulator controls whether the functional equipment is connected to the communication pipeline according to the following method:

Adjust the first type equipment regulator in the closed state, and adjust the second type equipment regulator in the open state, so that the functional equipment is connected to the communication pipeline. The pipeline where the first type equipment regulator is located is connected in parallel with the pipeline where the functional equipment is located, and the second type equipment regulator is adjacent to the functional equipment.

Adjust the first type equipment regulator in the open state, and adjust the second type equipment regulator in the closed state, so that the functional equipment is not connected to the communication pipeline.

In a possible embodiment, the modeling device further comprises:

A flow data configuration module, configured to construct a flow data configuration model, wherein the flow data configuration model configures the acquired flow data for the link unit, and the flow data includes inlet flow data and/or outlet flow data, and the data types in the flow data include at least one of the following: material flow data, energy flow data, value flow data and information flow data.

In a possible embodiment, the modeling device further comprises:

An environmental data configuration module for constructing an environmental data configuration model, wherein the environmental data configuration model configures the acquired environmental data for the link unit, and the data types of the environmental data include at least one of the following: water supply data, heat supply data, power supply data, steam supply data, material data, energy data and kinetic energy replenishment data.

It should be noted that the modeling devices of any of the above-mentioned link units can realize the modeling methods of the above-mentioned link units in one-to-one correspondence, and the details are not repeated here.

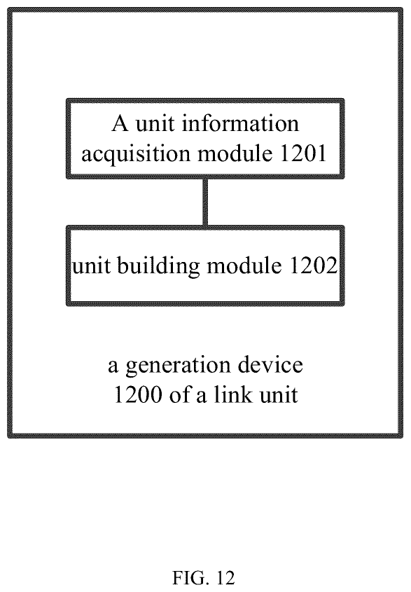

Based on the same idea, the embodiment of the present disclosure also provides a generation device for a link unit, which is used to realize the generation method of any link unit. FIG. 12 shows a schematic structural diagram of a generation device of a link unit provided by an embodiment of the present disclosure. Referring to FIG. 12, a generation device 1200 of a link unit provided by an embodiment of the present disclosure includes:

A unit information acquisition module 1201, configured to acquire the first quantity of previous processes, the second quantity of subsequent processes, the third quantity of target functional equipment in the target equipment group, equipment type information and connection relationship information among the target functional equipment.

The unit building module 1202 is used for adjusting the inlet regulator, the outlet regulator and the equipment regulator in the digital model of the link unit according to the first quantity, the second quantity, the third quantity, the equipment type information and the connection relationship information, so as to obtain a target link unit, and the communication pipeline contained in the target link unit is used for connecting each previous process with each subsequent process and realizing the functions corresponding to each target functional equipment.

In one possible embodiment, the unit building module 1202 is configured to:

Adjust the first quantity of inlet regulators and open the first quantity of inlet pipes.

Adjust the second quantity of outlet regulators and open the second quantity of outlet pipelines.

According to the third quantity, the equipment type information and the connection relationship information, adjusting the equipment regulator, and connecting each target functional equipment into the communication pipeline to obtain the target link unit.

In a possible embodiment, the target equipment group includes a plurality of target functional equipment, and the unit building module 1202 is used for:

Adjust each equipment regulator in that digital model of the link unit to be in a closed state.

Adjust the first type equipment regulator corresponding to each functional equipment in the digital model of the link unit to be in an open state.

According to the third quantity, the equipment type information and the connection relation information, selecting the functional equipment in the digital model of the link unit to obtain a target functional equipment group, wherein the quantity, the equipment type information and the connection relation between the first functional equipment in the target functional equipment group are consistent with the target equipment group.

Aim at any first target functional equipment in that target functional equipment group, adjusting the second-type equipment regulator correspond to the first target functional equipment to be in an open state, adjusting the first-type equipment regulator corresponding to the first target functional equipment to be in a closed state, and connecting each first target functional equipment into the communication pipeline to obtain a target link unit.

In a possible implementation, the generation device further comprises a flow configuration module, which is used for:
Acquire at least one flow data, wherein the flow data comprises at least one of material flow data, energy flow data, value flow data and information flow data;
Configure that at least one flow data for the digital model of the link unit.

In a possible implementation, the generation device further comprises an environment configuration module for:
Acquire at least one environmental data, wherein the environmental data comprises at least one of water supply data, heat supply data, power supply data, steam supply data, material data, energy data and kinetic energy replenishment data;
Configure that at least one environmental data for the digital model of the link unit.

It should be noted that any of the above-mentioned generation devices of link units can realize the above-mentioned generation methods of link units in one-to-one correspondence, and the details are not repeated here.

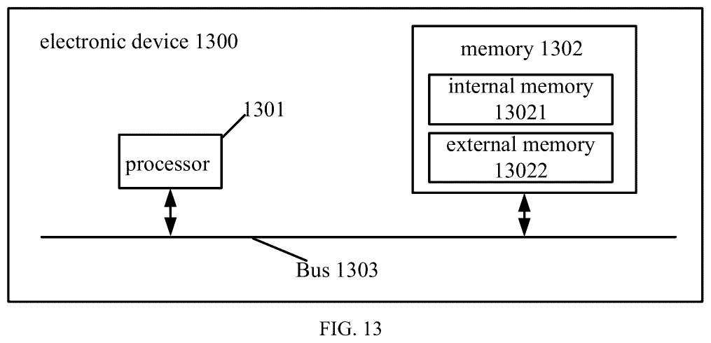

Based on the same technical concept, the embodiment of the disclosure also provides an electronic device. Referring to FIG. 13, the structural diagram of an electronic device provided for an embodiment of the present disclosure includes a processor 1301, a memory 1302, and a bus 1303. The memory 1302 is used to store execution instructions, including the internal memory 13021 and the external memory 13022; Here, the memory 13021, also called internal memory, is used for temporarily storing operation data in the processor 1301 and data exchanged with external memory 13022 such as hard disk. The processor 1301 exchanges data with the external memory 13022 through the internal memory 13021. When the electronic device 1300 is running, the processor 1301 communicates with the memory 1302 through the bus 1303, so that the processor 1301 is executing the following instructions:

Build an inlet pipeline model, wherein the inlet pipeline model comprises at least one inlet pipeline, the opening and closing of each inlet pipeline is controlled by an inlet regulator, and the connection mode between each inlet pipeline is parallel.

Build an outlet pipeline model, wherein the outlet pipeline model comprises at least one outlet pipeline, the opening and closing of each outlet pipeline is controlled by an outlet regulator, and the connection mode of each outlet pipeline is parallel.

Build a functional equipment group model, wherein the functional equipment group model comprises at least one functional equipment, and the functional equipment group model is respectively connected with the inlet pipeline model and the outlet pipeline model through pipelines, and the types of the functional equipment include at least one of the following: a buffer, a stirrer and a pressurizer, and the connection mode among the functional equipment is series or parallel, and whether each functional equipment is connected to a communication pipe routing equipment regulator is controlled, so that complete the modeling of the link unit, and obtain the digital model of the link unit.

Or execute the following instructions:

Acquire the first quantity of previous processes, the second quantity of subsequent processes, the third quantity of target functional equipment in the target equipment group, equipment type information and connection relationship information among the target functional equipment.

According to the first quantity, the second quantity, the third quantity, the equipment type information and the connection relationship information, the inlet regulator, the outlet regulator and the equipment regulator in the digital model of the link unit are adjusted to obtain a target link unit, and the communication pipeline contained in the target link unit is used for connecting each previous working procedure with each subsequent working procedure and realizing the functions corresponding to each target functional equipment.

The specific processing flow of the processor 1301 can refer to the description of the above method embodiment, and will not be repeated here.

In addition, the embodiment of the present disclosure also provides a computer-readable storage medium, on which a computer program is stored, and when the computer program is run by a processor, it executes the steps of the modeling method of the link unit or the generation method of the link unit described in the above method embodiment. Wherein the storage medium can be a volatile or nonvolatile computer-readable storage medium.

The embodiment of the present disclosure also provides a computer program product, which carries a program code, and the program code includes instructions that can be used to execute the steps of the modeling method of the link unit or the generation method of the link unit described in the above-mentioned method embodiment. For details, please refer to the above-mentioned method embodiment, which is not repeated here.

Wherein, the above computer program products can be realized by hardware, software or their combination. In one alternative embodiment, the computer program product is embodied as a computer storage medium, and in another alternative embodiment, the computer program product is embodied as a software product, such as a Software Development Kit (SDK) and the like.

It can be clearly understood by those skilled in the art that for the convenience and conciseness of description, the specific working process of the system and device described above can refer to the corresponding process in the aforementioned method embodiment, and will not be repeated here. In several embodiments provided by this disclosure, it should be understood that the disclosed systems, devices and methods can be realized in other ways. The device embodiments described above are only schematic. For example, the division of the units is only a logical function division, and there may be another division method in actual implementation. For example, multiple units or components may be combined or integrated into another system, or some features may be ignored or not implemented. On the other hand, the mutual coupling or direct coupling or communication connection shown or discussed can be indirect coupling or communication connection through some communication interfaces, devices or units, which can be in electrical, mechanical or other forms.

The units described as separate components may or may not be physically separated, and the components displayed as units may or may not be physical units, that is, they may be located in one place or distributed to multiple network units. Some or all of the units can be selected according to actual needs to achieve the purpose of this embodiment.

In addition, each functional unit in each embodiment of the present disclosure may be integrated into one processing unit, or each unit may exist physically alone, or two or more units may be integrated into one unit.

If the functions are realized in the form of software functional units and sold or used as independent products, they can be stored in a processor-executable nonvolatile computer-readable storage medium. Based on this understanding, the technical solution of the present disclosure can be embodied in the form of a software product, which is stored in a storage medium and includes several instructions to make a computer device (which can be a personal computer, a server, a network device, etc.) execute all or part of the steps of the method described in various embodiments of the present disclosure. The aforementioned storage media include: U disk, mobile hard disk, Read-Only Memory (ROM), Random Access Memory (RAM), magnetic disk or optical disk and other media that can store program codes.

The above is only the specific implementation of this disclosure, but the protection scope of this disclosure is not limited to this. Any person familiar with the technical field can easily think of changes or substitutions within the technical scope disclosed in this disclosure, and they should be included in the protection scope of this disclosure. Therefore, the scope of protection of this disclosure should be based on the scope of protection of the claims.

What is claimed is:

1. A modeling method of a link unit, characterized in that, the modeling method includes:
build an inlet pipeline model, wherein the inlet pipeline model comprises at least one inlet pipeline, the opening and closing of each inlet pipeline is controlled by an inlet regulator, and the connection mode between each inlet pipeline is parallel;
build an outlet pipeline model, wherein the outlet pipeline model comprises at least one outlet pipeline, the opening and closing of each outlet pipeline is controlled by an outlet regulator, and the connection mode of each outlet pipeline is parallel;
build a functional equipment group model, wherein the functional equipment group model comprises at least one functional equipment, and the functional equipment group model is respectively connected with the inlet pipeline model and the outlet pipeline model through pipelines, and the types of the functional equipment include at least one of the following: a buffer, a stirrer and a pressurizer, and the connection mode among the functional equipment is series or parallel, and whether each functional equipment is connected to a communication pipeline is controlled by an equipment regulator, so that complete the modeling of the link unit, and obtain the digital model of the link unit;
the equipment regulator controls whether the functional equipment is connected to the communication pipeline according to the following method:
adjust the first type equipment regulator in the closed state and the second type equipment regulator in the open state, so that the functional equipment is connected to the communication pipeline, the pipeline where the first type equipment regulator is located is connected in parallel with the pipeline where the functional equipment is located, and the second type equipment regulator is adjacent to the functional equipment;
adjust the first type equipment regulator in the open state, and adjust the second type equipment regulator in the closed state, so that the functional equipment is not connected to the communication pipeline.

2. The modeling method according to claim 1, characterized in that, before the step of completing the modeling of the link unit to obtain the digital model of the link unit, the modeling method further comprises:
build a flow data configuration model, wherein the flow data configuration model configures the acquired flow data for the link unit, and the flow data includes inlet flow data and/or outlet flow data, and the data types in the flow data include at least one of the following:
material flow data, energy flow data, value flow data and information flow data.

3. The modeling method according to claim 2, characterized in that, before the step of completing the modeling of the link unit to obtain the digital model of the link unit, the modeling method further comprises:
build an environmental data configuration model, wherein the environmental data configuration model configured the acquired environmental data for the link unit, and the data types of the environmental data include at least one of the following: water supply data, heat supply data, power supply data, steam supply data, material data, energy data and kinetic energy replenishment data.

4. A generation method for a link unit, characterized in that, uses the digital model of the link unit built by the modeling method of the link unit according to claim 3, and the generation method comprises
acquire the first quantity in the previous process, the second quantity in the later process, the third quantity of target functional equipment in the target equipment group, equipment type information and connection relationship information among the target functional equipment;
according to the first quantity, the second quantity, the third quantity, the equipment type information and the connection relationship information, adjust the inlet regulator, the outlet regulator and the equipment regulator in the digital model of the link unit to obtain a target link unit, and the communication pipeline contained in the target link unit is used for connecting each previous working procedure with each subsequent working procedure and realizing the functions corresponding to each target functional equipment.

5. The generation method according to claim 4, characterized in that, adjust the inlet regulator, the outlet regulator and the equipment regulator in the digital model of the link unit according to the first quantity, the second quantity, the third quantity, the equipment type information and the connection relationship information to obtain the target link unit, including:
adjust the first quantity of inlet regulators and opening the first quantity of inlet pipelines;
adjust a second quantity of outlet regulators and opening a second quantity of outlet pipelines;
according to the third quantity, the equipment type information and the connection relationship information, adjust the equipment regulator, and connecting each target functional equipment into the communication pipeline to obtain the target link unit.

6. The generation method according to claim 5, characterized in that, the target equipment group includes a plurality of target functional equipment, and adjusting the equipment regulator according to the third quantity, the equipment type information and the connection relationship information to connect each target functional equipment into the communication pipeline to obtain the target link unit, including:
adjust each equipment regulator in that digital model of the link unit to be in a closed state;
adjust the first type equipment regulator corresponding to each functional equipment in the digital model of the link unit to be in an open state;
according to the third quantity, the equipment type information and the connection relation information, select the functional equipment in the digital model of the link unit to obtain a target functional equipment group, wherein the quantity, the equipment type information and the connection relation between the first functional equipment in the target functional equipment group are consistent with the target equipment group;
aim at any first target functional equipment in that target functional equipment group, adjusting the second type equipment regulator correspond to the first target functional equipment to be in an open state, adjusting the first type equipment regulator corresponding to the first target functional equipment to be in a closed state, and connecting each first target functional equipment into the communication pipeline to obtain a target link unit.

7. The generation method according to claim 4, characterized in that, before the step of obtaining the target link unit, the generation method further comprises:
acquire at least one flow data, wherein the flow data comprises at least one of material flow data, energy flow data, value flow data and information flow data;
configure at least one flow data for the digital model of the link unit.

8. The generation method according to claim 4, characterized in that, before the step of obtaining the target link unit, the generation method further comprises:
acquire at least one environmental data, wherein the environmental data comprises at least one of water supply data, heat supply data, power supply data, steam supply data, material data, energy data and kinetic energy replenishment data;
configure at least one environmental data for the digital model of the link unit.

9. A generation device for a link unit, characterized in that, which is used to realize the generation method for a link unit according to claim 4, characterized in that the device comprises:
a unit information acquisition module, configured to acquire the first quantity of previous processes, the second quantity of subsequent processes, the third quantity of target functional equipment in the target equipment group, equipment type information and connection relationship information among the target functional equipment;
a unit building module, configured to adjust an inlet regulator, an outlet regulator and an equipment regulator in the digital model of the link unit according to the first quantity, the second quantity, the third quantity, the equipment type information and the connection relationship information, so as to obtain a target link unit, wherein the communication pipeline contained in the target link unit is used for connecting each preceding process with each succeeding process and realizing the functions corresponding to each target functional equipment.

10. A computer-readable storage medium, characterized in that, the computer-readable storage medium stores one or more programs, wherein the one or more programs, when executed by an electronic device including a plurality of application programs, cause the electronic device to perform the steps of the modeling method of a link unit according to claim 1.

11. A computer-readable storage medium, characterized in that, the computer-readable storage medium stores one or more programs, wherein the one or more programs, when executed by an electronic device including a plurality of application programs, cause the electronic device to execute the steps of the generation method for a link unit according to claim 4.
